(19) United States
(12) Patent Application Publication
(10) Pub. No.: US 2018/0366826 A1
(43) Pub. Date: Dec. 20, 2018

(54) PHASE SHIFT CIRCUIT AND POWER SUPPLY CIRCUIT

(71) Applicant: MITSUBISHI ELECTRIC CORPORATION, Tokyo (JP)

(72) Inventors: Hidenori YUKAWA, Tokyo (JP); Yu USHIJIMA, Tokyo (JP); Motomi WATANABE, Tokyo (JP); Naofumi YONEDA, Tokyo (JP)

(73) Assignee: MITSUBISHI ELECTRIC CORPORATION, Tokyo (JP)

(21) Appl. No.: 16/060,296

(22) PCT Filed: Mar. 18, 2016
(86) PCT No.: PCT/JP2016/058702

§ 371 Date: Jun. 7, 2018

(51) Int. Cl. H01Q 3/36; H01P 1/18

(52) U.S. Cl. CPC H01Q 3/36; H01P 1/182

(57) ABSTRACT

To achieve a phase shift circuit capable of obtaining good reflection characteristics and a desired phase shift amount at the center frequency without increasing the length in the propagating direction, the phase shift circuit includes: an input waveguide having an input terminal at one end; an output waveguide having an output terminal at one end; a middle waveguide whose thickness is thinner than a thickness of the input waveguide or the output waveguide and whose central position in a thickness direction different from a central position in the thickness direction of the input waveguide or the output waveguide; a first tapered waveguide which connects another end of the input waveguide with one end of the middle waveguide; and a second tapered waveguide which connects another end of the output waveguide with another end of the middle waveguide.

### TECHNICAL FIELD

The present invention relates to a phase shift circuit to be used mainly in VHF band, UHF band, microwave band, and millimeter wave band, and relates to a power supply circuit for supplying power to a multibeam antenna and the like.

### BACKGROUND ART

One example of antennas used for satellite communications is a multibeam antenna. A multibeam antenna includes one reflector antenna and a plurality of radiating elements, in which a plurality of beams is individually formed by any two or more of the radiating elements. In addition, adjacent beams typically overlap each other.

Such a multibeam antenna needs to have a power supply circuit for outputting a signal with a desired excitation amplitude and phase to each radiating element depending on the corresponding beam.

A power supply circuit for a multibeam antenna illustrated in FIG. 17 is known, for example. Herein, a case in which a beam 1 is formed with four radiating elements #1 to #4 and a beam 2 is formed with four radiating elements #3 to #6 as illustrated in FIG. 16 is illustrated. The two beams overlap each other by sharing the radiating elements #3 and #4.

In FIG. 17, reference numeral 7 denotes a first input terminal, reference numeral 8 denotes a second input terminal, reference numeral 9 denotes couplers, and reference numeral 10 denotes phase shift circuits. In addition, six output terminals #1 to #6 are included.

Next, operation will be explained. Signals derived from a signal input through the first input terminal 7 for the beam 1 are output to the respective output terminals #1 to #4, and signals derived from a signal input through the second input terminal 8 for the beam 2 are output to the respective output terminals #3 to #6. In addition, components included in the power supply circuit are typically constituted by respective rectangular waveguides whose wider wall surface size is referred to as A size and whose narrower wall surface size is referred to as B size. Herein, the A size and the B size of a waveguide will be referred to as width and thickness, respectively.

A phase shift circuit that is a component included in the power supply circuit will be described in a little more detail. FIG. 18 illustrates a possible phase shift circuit. Reference numeral 12 denotes a rectangular waveguide, reference numeral 13 (13a, 13b) denotes corners, reference numeral 14 denotes an input terminal, and reference numeral 15 denotes an output terminal. A wider wall surface of the rectangular waveguide is bent into a crank shape. Bent portions (corners 13) are rounded (corner and fillet radii) or cut so that good reflection characteristics can be obtained.

With this phase shift circuit, the height of the crank illustrated in FIG. 19 is changed, which can easily change the transmission phase between the input terminal 14 and the output terminal 15 without changing the positions of the input terminal 14 and the output terminal 15 to obtain a desired phase shift amount.

### CITATION LIST

### Patent Literature

Patent Literature 1: JP 2009-225001 A

### SUMMARY OF INVENTION

### Technical Problem

With the phase shift circuit of the related art, for achieving a small phase shift amount, the crank height illustrated in FIG. 19 needs to be decreased. Thus, the corners 13 come close to each other as illustrated in FIG. 20, which degrades the reflection characteristics owing to mutual influence. When the corners are close to each other, it is difficult to improve the reflection characteristics by rounding or cutting as illustrated in FIG. 20. In order to improve the reflection characteristics, the radii of the rounded corners need to be large as illustrated FIG. 21, which, however, increases the length in the propagating direction. Note that a desired phase shift amount can be obtained by increasing the crank height and further shifting the phase by 360 degrees than the desired shift amount at the center frequency of a band in use. The electrical length, however, becomes longer by one wavelength, which increases the frequency characteristics (the amount of change in phase relative to frequency) and results in characteristics of a narrow band. As described above, for achieving a small shift amount with the phase shift circuit of the related art, a problem that good reflection characteristics cannot be obtained is present.

The present invention has been made to solve such a problem as described above, and an object thereof is to achieve a phase shift circuit capable of obtaining good reflection characteristics and a desired phase shift amount at the center frequency without increasing the length in the propagating direction in applications such as a power supply circuit for a multibeam antenna.

### Solution to Problem

A phase shift circuit according to the present invention includes:

an input waveguide having an input terminal at one end;

an output waveguide having an output terminal at one end;

a middle waveguide whose thickness is thinner than a thickness of the input waveguide or the output waveguide and whose central position in a thickness direction different from a central position in the thickness direction of the input waveguide or the output waveguide;

a first tapered waveguide which connects another end of the input waveguide with one end of the middle waveguide; and

a second tapered waveguide which connects another end of the output waveguide with another end of the middle waveguide.

### Advantageous Effects of Invention

According to the present invention, a phase shift circuit capable of obtaining good reflection characteristics and a desired phase shift amount at the center frequency is achieved without increasing the length in the propagating direction.

### BRIEF DESCRIPTION OF DRAWINGS

FIG. 1 is a configuration diagram illustrating a phase shift circuit according to a first embodiment of the present invention.

FIG. 2 is an explanatory diagram for explaining the configuration of the phase shift circuit according to the first embodiment of the present invention.

FIG. 3 is an explanatory diagram for explaining the configuration of the phase shift circuit according to the first embodiment of the present invention.

FIG. 4 is an explanatory diagram for explaining the operation of the phase shift circuit according to the first embodiment of the present invention.

FIG. 5 is an explanatory diagram for explaining the operation of the phase shift circuit according to the first embodiment of the present invention.

FIG. 6 is an explanatory diagram for explaining the operation of the phase shift circuit according to the first embodiment of the present invention.

FIG. 7 is an explanatory diagram for explaining the operation of the phase shift circuit according to the first embodiment of the present invention.

FIG. 8 is an explanatory diagram for explaining the operation of the phase shift circuit according to the first embodiment of the present invention.

FIG. 9 is an explanatory graph for explaining the operation of the phase shift circuit according to the first embodiment of the present invention.

FIG. 10 is an explanatory graph for explaining the operation of the phase shift circuit according to the first embodiment of the present invention.

FIG. 11 is a configuration diagram illustrating a phase shift circuit according to a second embodiment of the present invention.

FIG. 12 is a configuration diagram illustrating a phase shift circuit according to a third embodiment of the present invention.

FIG. 13 is a configuration diagram illustrating a phase shift circuit according to a fourth embodiment of the present invention.

FIG. 14 is a configuration diagram illustrating a phase shift circuit according to a fifth embodiment of the present invention.

FIG. 15 is a configuration diagram illustrating a power supply circuit according to a sixth embodiment of the present invention.

FIG. 16 is an explanatory diagram for explaining the operation of the power supply circuit according to the sixth embodiment of the present invention.

FIG. 17 is a configuration diagram illustrating a power supply circuit of a related art.

FIG. 18 is a configuration diagram illustrating a phase shift circuit of a related art.

FIG. 19 is a configuration diagram illustrating a phase shift circuit of a related art.

FIG. 20 is a configuration diagram illustrating a phase shift circuit of a related art.

FIG. 21 is a configuration diagram illustrating a phase shift circuit of a related art.

### DESCRIPTION OF EMBODIMENTS

### First Embodiment

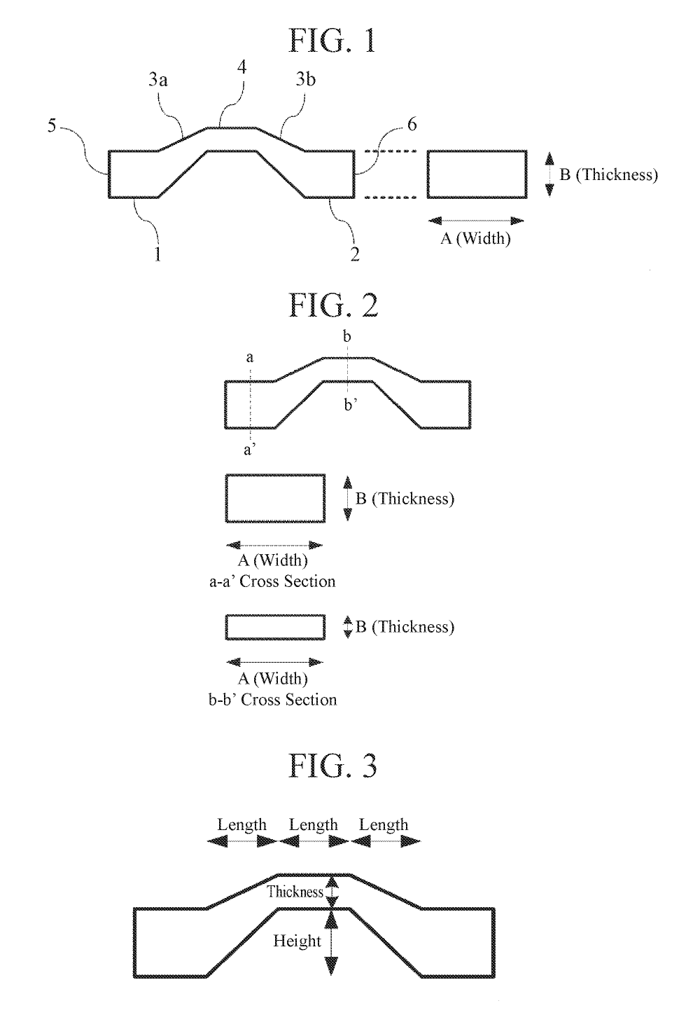

FIG. 1 is a configuration diagram illustrating a phase shift circuit according to a first embodiment of the present invention. A side view of waveguides for explaining the phase shift circuit is illustrated. In FIG. 1, reference numeral 1 denotes an input waveguide, reference numeral 2 denotes an output waveguide, reference numeral 3 (3a, 3b) denotes tapered waveguides, reference numeral 3a denotes a first tapered waveguide, reference numeral 3b denotes a second tapered waveguide, reference numeral 4 denotes a middle part waveguide with a small thickness, which is a middle waveguide, reference numeral 5 denotes an input terminal provided at the input waveguide 1, and reference numeral 6 denotes an output terminal provided at the output waveguide 2.

The phase shift circuit illustrated in FIG. 1 is constituted by rectangular waveguides whose wider wall surface size is referred to as A size (width) and whose narrower wall surface size is referred to as B size (thickness), in which the input waveguide 1 and one end of the middle part waveguide 4 are connected via the tapered waveguide 3a therebetween and the output waveguide 2 and the other end of the middle part waveguide 4 are connected via the tapered waveguide 3b therebetween. Note that, as illustrated in FIG. 2, the middle part waveguide 4 is thinner in the thickness direction than the input waveguide 1 and the output waveguide 2, that is, has a different thickness from those of the input waveguide 1 and the output waveguide 2. The middle part waveguide 4 is disposed with a central position thereof shifted in the thickness direction relative to the input waveguide 1 and the output waveguide 2.

Specifically, the phase shift circuit illustrated in FIG. 1 includes the input waveguide having the input terminal at one end, the output waveguide having the output terminal at one end, the middle waveguide which is thinner than the input waveguide or the output waveguide and has a central position in the thickness direction different from that of the input waveguide or the output waveguide, the first tapered waveguide connecting the other end of the input waveguide with one end of the middle waveguide, and the second tapered waveguide connecting the other end of the output waveguide with the other end of the middle waveguide.

Next, operation will be explained.

When a signal is input from the input terminal 5, the signal propagates through the input waveguide 1, the tapered waveguide 3a, the middle part waveguide 4, the tapered waveguide 3b, and the output waveguide 2, and is output to the output terminal 6.

The input terminal 5 and the output terminal 6 are at specified positions, and the position of the middle part waveguide 4 is shifted and offset relative to the positions of the input waveguide 1 and the output waveguide 2 in the thickness direction of the waveguides so that a phase shift amount of a signal passing from the input terminal 5 to the output terminal 6 is set to a desired value.

This offset makes the electrical length of a signal propagating through the waveguides larger than that through waveguides having a shape obtained by linearly connecting the input waveguide 1 and the output waveguide 2. Since the change in the electrical length causes the transmission phase between the input terminal 5 and the output terminal 6 to change, the phase shift circuit operates with a fixed phase shift value.

In this case, for obtaining a small phase shift amount, the height of the middle part waveguide 4 is set to be low and the offset value is set to be small; however, degradation in the characteristics, which is caused due to a connecting portion 3a of the input waveguide 1 and the tapered waveguide and a connecting portion of the tapered waveguide 3b and the middle part waveguide 4 being close to each other and due to a connecting portion 3b of the output waveguide 2 and the tapered waveguide and a connecting portion of the tapered waveguide 3b and the middle part waveguide 4 being close to each other, can be corrected by changing the thickness and the length of the middle part waveguide 4 and the lengths of the tapered waveguides 3a and 3b.

Thus, as illustrated in FIG. 3, reflection characteristics and transmission characteristics are determined by the height, length and thickness of each of the waveguides.

Next, the principles of improvement in reflection characteristics will be described.

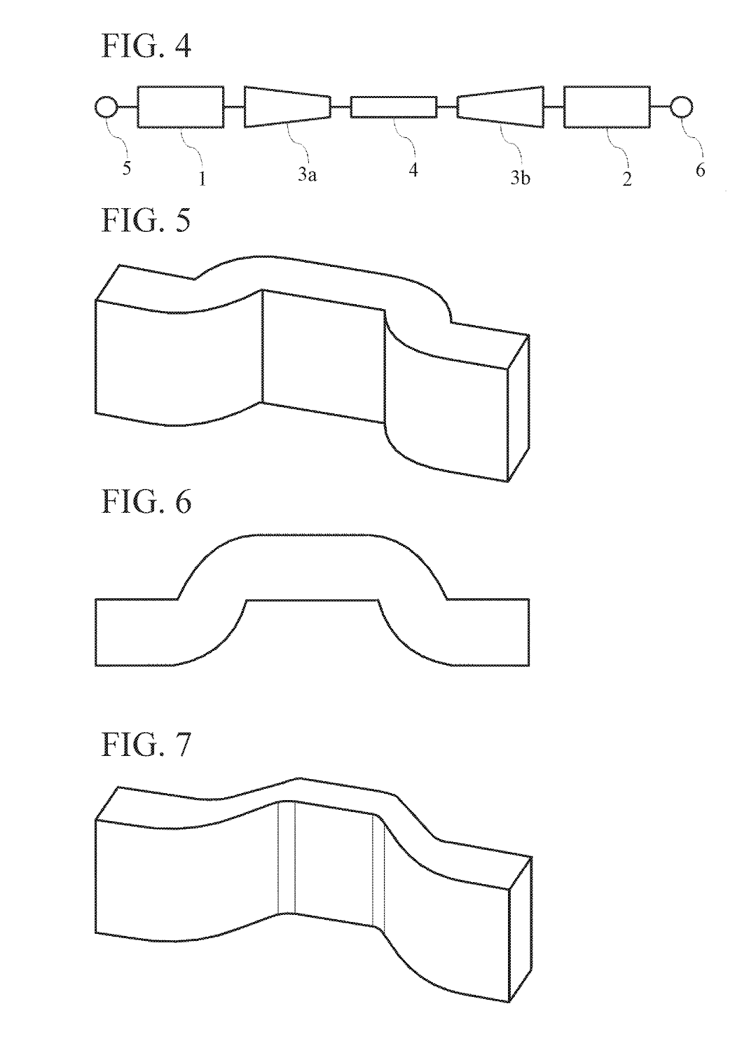

The characteristic impedance of a waveguide depends on the thickness of the waveguide. This means that, in a case of an equivalent circuit of the phase shift circuit of the present invention, the tapered waveguide 3a transforms the impedance of the input waveguide 1 to the impedance of the middle part waveguide 4, and the tapered waveguide 3b transforms the impedance of the middle part waveguide 4 to the impedance of the output waveguide 2, as illustrated in FIG. 4. Such an impedance transforming circuit achieves good reflection characteristics in a desired band.

Thus, even in a case where a small phase shift amount is desired to be obtained, an effect of achieving the desired phase shift amount and good reflection characteristics is produced without increasing the length in the propagating direction.

The reasons for which good reflection characteristics are achieved can be that, in FIG. 4, a signal input to the input terminal 5 is reflected at each of the connecting portion of the input waveguide 1 and the tapered waveguide 3a, the connecting portion of the tapered waveguide 3a and the middle part waveguide 4, the connecting portion of the middle part waveguide 4 and the tapered waveguide 3b, and the connecting portion of the tapered waveguide 3b and the output waveguide 2, and the reflected waves act to cancel each other at the input terminal 5.

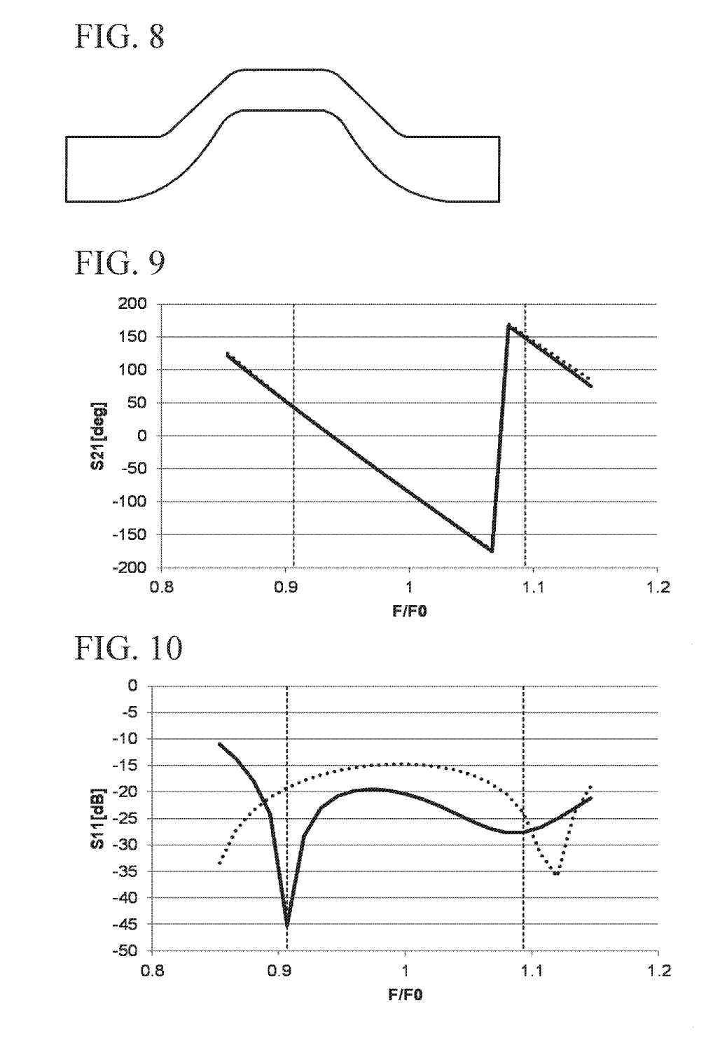

To validate the above, results of magnetic field calculation that have confirmed the effects of the present invention will be presented. FIGS. 5 and 6 are a perspective view and a side view, respectively, of a phase shift circuit of a related art, and FIGS. 7 and 8 are a perspective view and a side view, respectively, of the phase shift circuit according to the present invention. The position of each of the input terminal 5 and the output terminal 6 is the same as in both cases. Thus, the length in the tube axial direction is the same in both cases. In addition, in both cases, corners are rounded (corner and fillet radii).

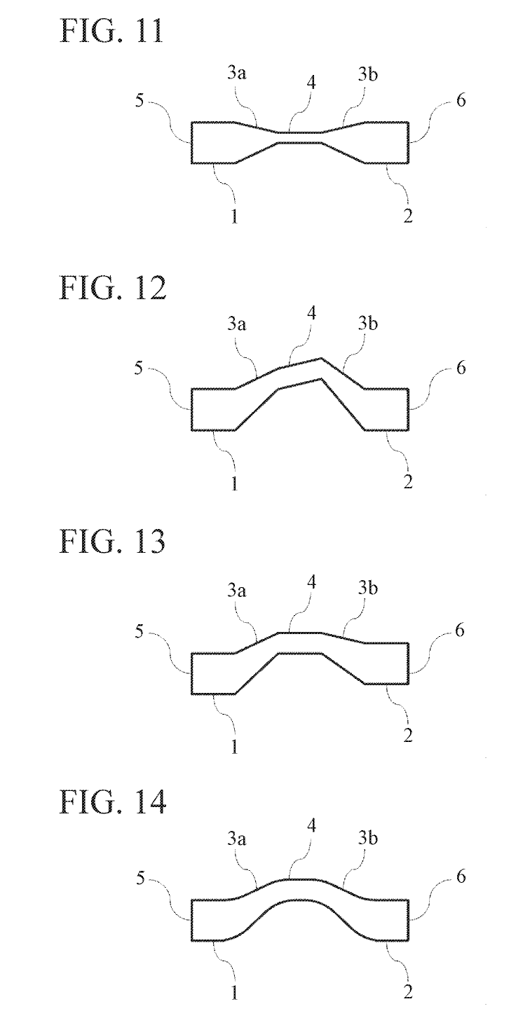

Design is conducted on a fractional bandwidth of 20% so that the transmission phase is about −80 degrees at the center frequency. The input terminal is referred to as a terminal 1, the output terminal is referred to as a terminal 2, FIG. 9 shows the transmission phase (S21 phase) between the input terminal and the output terminal, and FIG. 10 shows the reflection characteristics (S11 amplitude) at the input terminal.

In the figures, solid lines represent calculation results for the phase shift circuit according to the first embodiment of the present invention, and dotted lines represent calculation results for the phase shift circuit of the related art. As seen in FIG. 9, the transmission phase characteristics are substantially the same in both cases, in which a transmission phase of about −80 degrees is obtained at the center frequency. In contrast, as seen in FIG. 10, while high reflection of about −15 dB is obtained with the phase shift circuit of the related art, reflection of a low value of about −20 dB is obtained and the reflection characteristics are thus improved by about 5 dB with the phase shift circuit of the present invention. As described above, it is confirmed that good reflection characteristics are achieved without increasing the length in the propagating direction as compared to the related art.

While a case in which rectangular waveguides are used for waveguides such as the middle part waveguide 4 constituting the phase shift circuit has been presented in the first embodiment, the waveguides are not limited thereto, and waveguides other than rectangular, such as those having elliptic or oval cross sections, may be used.

In addition, while a signal is input through the input terminal 5 provided at the input waveguide 1 and output through the output terminal 6 provided at the output waveguide 2 in the above description, similar operation is clearly achieved even when a signal is input through the output terminal 6 and output through the input terminal 5, and input and output of a signal may thus be reversed.

As described above, according to the phase shift circuit presented in the first embodiment, an effect of achieving a phase shift circuit capable of obtaining good reflection characteristics and a desired phase shift amount at the center frequency in a wide band without increasing the length in the propagating direction is produced.

### Second Embodiment

FIG. 11 is a configuration diagram illustrating a phase shift circuit according to a second embodiment of the present invention. A side view of waveguides for explaining the phase shift circuit is illustrated.

In FIG. 11, the offset value in the height direction of the middle part waveguide 4 is smaller than that in the phase shift circuit presented in the first embodiment, so that the position of the middle part waveguide 4 is within the size in the thickness direction of the input waveguide 1 or the output waveguide 2.

In other words, the positional range in the thickness direction of the middle waveguide does not exceed the positional range in the thickness direction of the input waveguide or the output waveguide.

As illustrated in FIG. 11, the height of the middle part waveguide 4 may be smaller than that of the input waveguide 1 or the output waveguide 2. In this case as well, the effects similar to those of the phase shift circuit presented in the first embodiment are produced. In addition, an effect of miniaturizing the phase shift circuit is also produced.

### Third Embodiment

FIG. 12 is a configuration diagram illustrating a phase shift circuit according to a third embodiment of the present invention.

In FIG. 12, the middle part waveguide 4 is disposed to be inclined relative to the central axis of the input waveguide 1 or the output waveguide 2 as compared to the phase shift circuit presented in the first embodiment. In other words, the central axis of the middle waveguide is inclined relative to the central axis of the input waveguide or the output waveguide.

As illustrated in FIG. 12, the central axis of the middle part waveguide 4 and that of the input waveguide 1 or the output waveguide 2 need not be parallel to each other. In this case as well, the effects similar to those of the phase shift circuit presented in the first embodiment are produced. In addition, an effect of further increasing design flexibility of the phase shift circuit is also produced.

While the middle part waveguide 4 is inclined in the height direction so that the level difference in the height direction between the input waveguide 1 and the middle part waveguide 4 is smaller than the level difference between the output waveguide 2 and the middle part waveguide 4 in FIG. 12, the middle part waveguide 4 may be inclined so that the level difference between the input waveguide 2 and the middle part waveguide 4 is smaller.

### Fourth Embodiment

FIG. 13 is a configuration diagram illustrating a phase shift circuit according to a fourth embodiment of the present invention.

In FIG. 13, the input waveguide 1 and the output waveguide 2 are positioned with respective offsets so that the positions in the height direction of the input waveguide 1 and the output waveguide 2 are different from each other as compared to the phase shift circuit presented in the first embodiment. In other words, the center positions in the thickness direction of the input waveguide and the output waveguide are different from each other.

As illustrated in FIG. 13, the heights of the input waveguide 1 and the output waveguide 2 may be offset. In this case as well, the effects similar to those of the phase shift circuit presented in the first embodiment are produced. In addition, an effect of further increasing layout design flexibility when the phase shift circuit is used as a power supply circuit for a multibeam antenna is also produced.

While the offsets in the height direction are provided so that the level difference in the height direction between the input waveguide 1 and the middle part waveguide 4 is larger than the level difference between the output waveguide 2 and the middle part waveguide 4 in FIG. 13, offsets may be provided so that the level difference between the input waveguide 2 and the middle part waveguide 4 is larger.

### Fifth Embodiment

FIG. 14 is a configuration diagram illustrating a phase shift circuit according to a fifth embodiment of the present invention.

In FIG. 14, the connecting portion of the input waveguide 1 and the tapered waveguide 3a, the connecting portion of the tapered waveguide 3a and the middle part waveguide 4, the connecting portion of the middle part waveguide 4 and the tapered waveguide 3b, and the connecting portion of the tapered waveguide 3b and the output waveguide 2 are each formed in an arc shape and rounded (corner and fillet radii). In other words, each of the connecting portions of the input waveguide and the first tapered waveguide, the first tapered waveguide and the middle waveguide, the middle waveguide and the second tapered waveguide, and the second tapered waveguide and the output waveguide at least partly has an arc shape.

As illustrated in FIG. 14, each waveguide connecting portion may be rounded. In this case as well, the effects similar to those of the phase shift circuit presented in the first embodiment are produced. Note that in manufacture of a phase shift circuit, an end mill may be used for processing waveguides which constitute the phase shift circuit into the respective shapes, and when an end mill is used, a drill with a small diameter needs to be used for partly cutting at an angle smaller than 180 degrees, which makes the processing troublesome. With the phase shift circuit of the present embodiment, however, parts having shapes with angles smaller than 180 degrees are decreased or eliminated, which also produces an effect of facilitating processing with an end mill.

### Sixth Embodiment

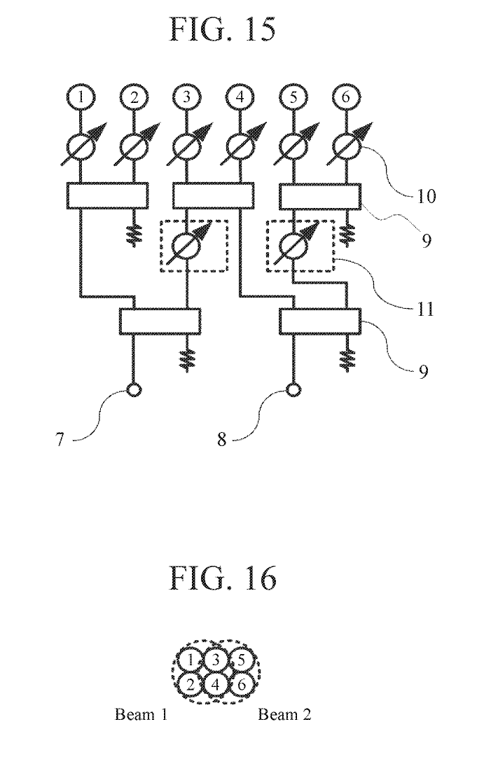

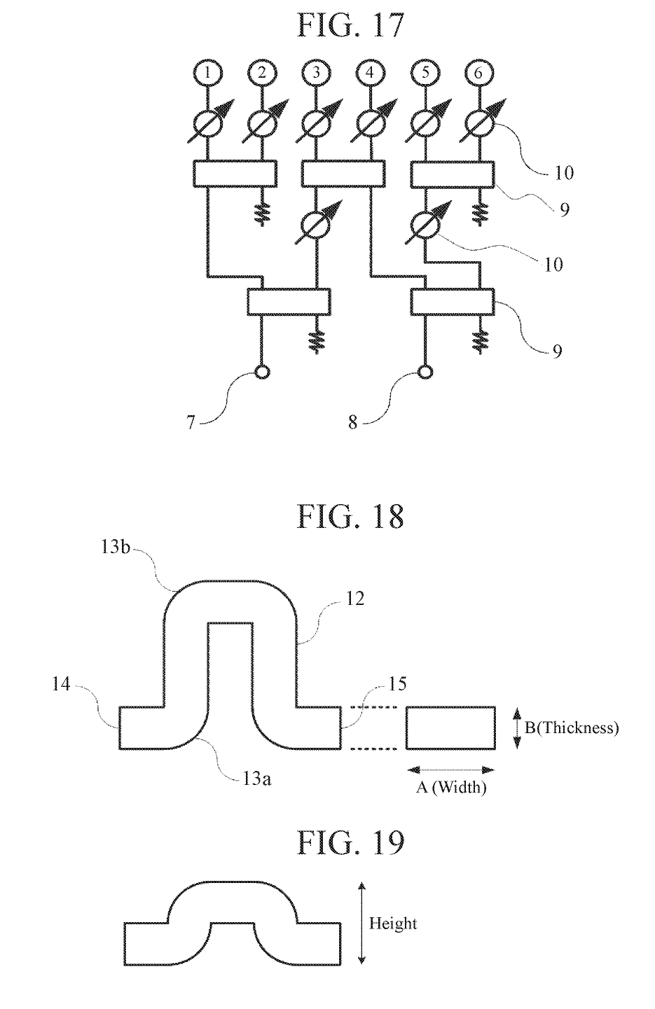

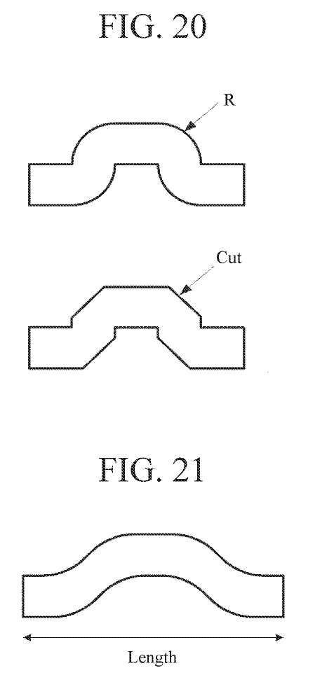

FIGS. 15 and 16 are a circuit diagram and a beam diagram, respectively, for explaining a power supply circuit for a multibeam antenna according to a sixth embodiment of the present invention. In the figures, reference numeral 7 denotes a first input terminal, reference numeral 8 denotes a second input terminal, reference numeral 9 denotes couplers, reference numeral 10 denotes first phase shift circuits, and reference numeral 11 denotes second phase shift circuits. In FIG. 15, terminals with numbers 1 to 6 are output terminals to be connected with and supply power to respective radiating elements of a multibeam antenna. A phase shift circuit of a related art is applied to the first phase shift circuits, and a phase shift circuit presented in any one of the first to fifth embodiments of the present invention is applied to the second phase shift circuits.

In other words, the power supply circuit includes a plurality of phase shift circuits each of which is constituted by waveguides, and at least one of the phase shift circuits is the phase shift circuit presented in any one of the first to fifth embodiments.

In addition, in the power supply circuit of FIG. 15, at least one of the phase shift circuits is a phase shift circuit of a related art including an input waveguide having an input terminal at one end, an output waveguide having an output terminal at one end, and a middle waveguide connected with the other end of the input waveguide and the other end of the output waveguide and having a thickness equal to that of the input waveguide and the output waveguide.

In FIG. 15, the power supply circuit forms a beam 1 with four radiating elements #1 to #4 and a beam 2 with four radiating elements #3 to #6 as illustrated in FIG. 16. The two beams 1 and 2 overlap each other by sharing the radiating elements #3 and #4. In addition, the power supply circuit, for forming the beams, includes the first input terminal 7, the second input terminal 8, and six output terminals #1 to #6, and also includes the couplers 9 and the phase shift circuits 10 and 11.

Next, operation will be explained. Signals derived from a signal input through the first input terminal 7 for forming the beam 1 are output to the respective output terminals #1 to #4 via any two of the couplers 9 and the respective first phase shift circuits 10, and partly via a second phase shift circuit 11. Signals derived from a signal input through the second input terminal 8 for forming the beam 2 are output to the respective output terminals #3 to #6 via any two of the couplers 9 and the respective first phase shift circuits 10, and partly via a second phase shift circuit 11. In addition, components included in the power supply circuit are constituted by respective waveguides such as rectangular waveguides.

In this case, one first phase shift circuit 10 is disposed as the phase shift circuit on a path of each of the signals which are derived from the signal input through the first input terminal 7 and output to the respective output terminals #1 and #2. In addition, one first phase shift circuit 10 and one common second phase shift circuit 11, that is, a total of two phase shift circuits are disposed as the phase shift circuits on a path of each of the signals which are derived from the signal input through the first input terminal 7 and output to the respective output terminals #3 and #4. Similar configurations are provided on the respective paths having input through the second input terminal 8.

Among these paths, at least one second phase shift circuit 11 is provided on each of the paths on which two phase shift circuits are disposed. In contrast, a second phase shift circuit 11 is not (necessarily) disposed on each of the paths on which one phase shift circuit is disposed. Thus, a phase shift circuit presented in any of the first to fifth embodiments is applied to one of two phase shift circuits on a long path along which the two phase shift circuits are passed through.

In other words, the power supply circuit includes at least one input terminal and a plurality of output terminals, in which a phase shift circuit presented in any of the first to fifth embodiments is used as at least one phase shift circuit on a path along which more phase shift circuits are disposed than along another path among a plurality of paths from the input terminal to the respective output terminals.

In a case where only phase shift circuits of a related art are used, for achieving a small phase shift amount while obtaining good reflection characteristics, the phase may need to be shifted further by 360 degrees than a required amount, which increases the differences between frequency characteristics of the phases (gradients of transmission phases relative to frequencies) at the respective output terminals as described above. This poses the problem that the frequency band in which good characteristics can be obtained is narrow.

In contrast, in the case of a power supply circuit to which the phase shift circuit of the present invention is applied, the phase shift circuit does not need to further shift the phase by 360 degrees than a required amount, which produces an effect of achieving the power supply circuit that reduces the differences between the frequency characteristics of the phases at the respective output terminals and obtains good excitation phase distribution in a wide band.

Furthermore, since at least one phase shift circuit on a path along which more phase shift circuits are disposed than along another path is the phase shift circuit presented in any of the first to fifth embodiments herein, an effect of achieving a power supply circuit that makes the phase shift amount smaller particularly on a path along which the phase change is large and obtains good frequency characteristics is produced.

In addition, since the sizes in the width direction of the phase shift circuits can be decreased in a power supply circuit including a large number of phase shift circuits, an effect of miniaturizing the power supply circuit is produced. Furthermore, an effect of facilitating arrangement of the phase shift circuits within a limited space for installing the power supply circuit is produced.

While the cases in which the phase shift circuit presented in any of the first to fifth embodiments is applied to one of two phase shift circuits on a long path along which the two phase shift circuits are passed through are presented herein, the phase shift circuit presented in any of the first to fifth embodiments may be applied to the two phase shift circuits on the same path depending on the frequency characteristics of the phases at the respective output terminals, and alternatively may be applied to phase shift circuits on other paths.

While the power supply circuit for supplying power to a multibeam antenna is presented in the sixth embodiment, the power supply circuit is not limited thereto, and may be for supplying power for a purpose of generally distributing signals or for other uses. Furthermore, while the case in which a signal is input through each of the first input terminal 7 and the second input terminal 8 and signals derived from the corresponding input signal are output to the respective output terminals #1 to #6, and the like is presented, a signal may be input through any of the output terminals #1 to #6 and a signal derived from the input signal may be output to the first input terminal 7 or the second input terminal 8, which also produces the effects of the present embodiment.

### INDUSTRIAL APPLICABILITY

A phase shift circuit according to the present invention is applicable to a multibeam antenna in a form of a component of a power supply circuit or the like.

### REFERENCE SIGNS LIST

1: input waveguide, 2: output waveguide, 3, 3a, 3b: tapered waveguide, 4: middle part waveguide, 5: input terminal, 6: output terminal, 7: first input terminal, 8: second input terminal, 9: coupler, 10: first phase shift circuit, 11: second phase shift circuit, 12: rectangular waveguide, 13, 13a, 13b: corner, 14: input terminal, 15: output terminal

1. A phase shift circuit comprising:
an input waveguide having an input terminal at one end;
an output waveguide having an output terminal at one end;
a middle waveguide whose thickness is thinner than a thickness of the input waveguide or the output waveguide and whose central position in a thickness direction different from a central position in the thickness direction of the input waveguide or the output waveguide;
a first tapered waveguide which connects another end of the input waveguide with one end of the middle waveguide; and
a second tapered waveguide which connects another end of the output waveguide with another end of the middle waveguide.

2. The phase shift circuit according to claim 1, wherein the middle waveguide is a rectangular waveguide.

3. The phase shift circuit according to claim 1, wherein the middle waveguide has a positional range in the thickness direction within a positional range in the thickness direction of the input waveguide or the output waveguide.

4. The phase shift circuit according to claim 1, wherein the middle waveguide has a central axis inclined relative to a central axis of the input waveguide or the output waveguide.

5. The phase shift circuit according to claim 1, wherein central positions in the thickness direction of the input waveguide and the output waveguide are different from each other.

6. The phase shift circuit according to claim 1, wherein connecting portions of the input waveguide and the first tapered waveguide, the first tapered waveguide and the middle waveguide, the middle waveguide and the second tapered waveguide, and the second tapered waveguide and the output waveguide at least partly have respective arc shapes.

7. A power supply circuit comprising a plurality of phase shift circuits each of which is constituted by waveguides, wherein
at least one of the phase shift circuits is the phase shift circuit according to claim 1.

8. The power supply circuit according to claim 7, wherein the power supply circuit supplies power to a multibeam antenna.

9. The power supply circuit according to claim 7, wherein at least one of the phase shift circuits includes:
an input waveguide having an input terminal at one end;
an output waveguide having an output terminal at one end; and
a middle waveguide which is connected with another end of the input waveguide and connected with another end of the output waveguide and whose thickness equal to a thickness of the input waveguide and the output waveguide.

10. The power supply circuit according to claim 7, comprising:
at least one input terminal; and
a plurality of output terminals, wherein
the phase shift circuit is used as at least one phase shift circuit on a path along which more phase shift circuits are disposed than along another path among a plurality of paths from the input terminal to the respective output terminals.
